(19) United States
(12) Patent Application Publication
(10) Pub. No.: US 2026/0185963 A1
(43) Pub. Date: Jul. 2, 2026

(54) GRADIENT-AUGMENTED SATURATION MAGNETIZATION INTERNAL INSPECTION DEVICE FOR OIL AND GAS PIPELINES AND METHOD THEREFOR

(71) Applicant: China Special Equipment Inspection and Research Institute, Beijing (CN)

(72) Inventors: Jinzhong CHEN, Beijing (CN); Jiaxing XIN, Beijing (CN); Chang LIU, Beijing (CN); Ziqing CHEN, Beijing (CN)

(21) Appl. No.: 19/344,285

(22) Filed: Sep. 29, 2025

(30) Foreign Application Priority Data
Dec. 26, 2024 (CN) 202411932943.8

(51) Int. Cl. G01N 27/87; F17D 5/06

(52) U.S. Cl. CPC G01N 27/87; F17D 5/06

(57) ABSTRACT

Disclosed in the present disclosure are a gradient-augmented saturation magnetization internal inspection device for oil and gas pipelines and a method therefor. The apparatus includes a pipeline-segment excitation assembly and a plurality of probe local excitation assemblies. The pipeline-segment excitation assembly includes an annular rigid framework, pipeline-segment magnetization magnets, pipeline-segment steel brushes; pipeline-segment magnetization magnets are respectively sleeved over an outer sidewall of the annular rigid framework; a first pipeline-segment steel brush is sleeved over an outer sidewall of a first pipeline-segment magnetization magnet, and a second pipeline-segment steel brush is sleeved over an outer sidewall of a second pipeline-segment magnetization magnet. The plurality of probe local excitation assemblies include gradient-augmented magnetization probes and probe brackets, and the gradient-augmented magnetization probes are disposed in a circumferential array on the annular rigid framework through the probe brackets.

### CROSS-REFERENCE TO RELATED APPLICATION

This application claims priority to Chinese Patent Application No. 202411932943.8, filed on Dec. 26, 2024, which is hereby incorporated by reference its entirety.

### TECHNICAL FIELD

The present disclosure relates to the technical field of the internal inspection of oil and gas pipelines, and particularly to a gradient-augmented saturation magnetization internal inspection device for oil and gas pipelines and method therefor.

### BACKGROUND

During the long-term operation of oil and gas pipelines, defects such as cracking, corrosion, and wear of the pipelines may occur due to natural aging of the pipelines, soil subsidence and rockfall impacts, etc. These defects may lead to oil and gas leakage and then cause serious safety accidents. Therefore, the regular monitoring and the safety assessment of the pipelines are critical for the safe operation of the pipelines.

At present, the pipeline internal inspection technology serves as one of the important means for the state perception and the safety maintenance of pipeline bodies, including a magnetic flux leakage detection technology, an ultrasonic testing technology, an eddy current testing technology, etc. An internal inspector is an inspection device which integrates functions such as detection, information collection and processing, etc., and is mainly employed for comprehensive inspection of oil and gas pipeline defects.

The traditional magnetic flux leakage detection is a mature internal inspection technology, which has the advantages of high sensitivity, couplant-free operation, high noise immunity, etc. However, the traditional magnetic flux leakage detection device applies saturation magnetization to an entire section of pipeline, resulting in the waste of magnetic field resources. Meanwhile, the volume, the weight and the magnetic attractive force of the magnetic flux leakage detection device are large, and it is difficult for the media in a low-pressure pipeline to drive the magnetic flux leakage detection device, resulting in that the traditional magnetic flux leakage detection device is not suitable for the medium-and-low-pressure pipelines.

In addition, a magnetic flux leakage detection probe supports an inner wall of a pipeline through a flexible mechanical structure. The magnetic flux leakage detection device vibrates significantly when passing through a weld seam or a valve, which causes a lift-off effect of the magnetic flux leakage detection probe and leads to the obvious degradation of the detection signal quality of the probe. Therefore, the traditional magnetic flux leakage detection device has obvious limitations in the detection of the defects of medium-and low-pressure pipelines.

This section is intended to provide background or context for the embodiments of the present disclosure set forth in the claims. The description here should not be admitted to be the prior art just because it is included in this section.

### SUMMARY

The embodiments of the present disclosure provide a gradient-augmented saturation magnetization internal inspection device for oil and gas pipelines and a method therefor, which are used to carry out an accurate saturation magnetization on a pipeline area covered by a probe to save magnetic field resources, thereby achieving a lightweight in-pipeline defect detection.

In order to solve the above technical problems, the present disclosure provides the following technical solutions.

In a first aspect, an embodiment of the present disclosure provides a gradient-augmented saturation magnetization internal inspection device for oil and gas pipelines, which is used to carry out an accurate saturation magnetization on a pipeline area covered by a probe, so as to save magnetic field resources and reduce a volume and a weight of a pipeline-segment excitation assembly, thereby achieving a lightweight in-pipeline defect detection. The device includes: a pipeline-segment excitation assembly and a plurality of probe local excitation assemblies;

the pipeline-segment excitation assembly includes an annular rigid framework, a first pipeline-segment magnetization magnet, a second pipeline-segment magnetization magnet, a first pipeline-segment steel brush and a second pipeline-segment steel brush; the first pipeline-segment magnetization magnet, the second pipeline-segment magnetization magnet, the first pipeline-segment steel brush and the second pipeline-segment steel brush are all annular structures; the first pipeline-segment magnetization magnet and the second pipeline-segment magnetization magnet are respectively sleeved over an outer sidewall of the annular rigid framework, and are oppositely polarized; the first pipeline-segment steel brush is sleeved over an outer sidewall of the first pipeline-segment magnetization magnet, and the second pipeline-segment steel brush is sleeved over an outer sidewall of the second pipeline-segment magnetization magnet; and

the plurality of probe local excitation assemblies includes gradient-augmented magnetization probes and probe brackets, and the gradient-augmented magnetization probes are disposed in a circumferential array on the annular rigid framework through the probe brackets.

Further, when the gradient-augmented saturation magnetization internal inspection device is disposed in a to-be-inspected pipeline, the first pipeline-segment steel brush and the second pipeline-segment steel brush are attached to an inner wall of the to-be-inspected pipeline, so that the annular rigid framework, together with the first pipeline-segment magnetization magnet, the second pipeline-segment magnetization magnet, the first pipeline-segment steel brush, the second pipeline-segment steel brush and the to-be-inspected pipeline collectively forms a first magnetic field circuit.

Further, the gradient-augmented magnetization probe includes a first probe yoke, a second probe yoke, a probe magnetization magnet and a magnetic sensitive element; the first probe yoke, the probe magnetization magnet, the second probe yoke and the to-be-inspected pipeline form a second magnetic field circuit; and the first magnetic field circuit and the second magnetic field circuit are in a same direction.

Further, the gradient-augmented magnetization probe further includes a printed circuit board on which the magnetic sensitive element is disposed, the magnetic sensitive element and the printed circuit board are disposed between the first probe yoke and the second probe yoke, and the first probe yoke and the second probe yoke are disposed on the probe magnetization magnet.

Further, the gradient-augmented magnetization probe further includes a wear-resistant plate, a plurality of wear-resistant pins and a probe framework; the magnetic sensitive element, the printed circuit board, the first probe yoke, the second probe yoke and the probe magnetization magnet are encapsulated within the probe framework, and the wear-resistant plate covers the magnetic sensitive element, the first probe yoke and the second probe yoke and is fixed by the wear-resistant pins.

Further, the probe bracket includes two probe support arms and a tension spring; one end of either of the probe support arms is rotatably connected to the probe framework, and the other end of either of the probe support arms is rotatably connected to the annular rigid framework; one end of the tension spring is fixed on an upper region of one of the probe support arms, and the other end of the tension spring is fixed on a lower region of the other of the probe support arms.

Further, the probe bracket further includes a plurality of screws, either of the probe support arms is provided with an elongated through-slot, one end of the tension spring is fixed on an upper region of the elongated through-slot of one of the probe support arms through the screws, and the other end thereof is fixed on a lower region of the elongated through-slot of the other of the probe support arms.

Further, the probe bracket further includes a plurality of bolts and a probe base; the probe base is fixed on the annular rigid framework, and the probe support arms are rotatably connected to the probe base through the bolts.

Further, a longitudinal direction of the probe magnetization magnet is aligned with an axial direction of the to-be-inspected pipeline.

In a second aspect, the present disclosure further provides a gradient-augmented saturation magnetization internal inspection method for oil and gas pipelines, including:
applying a non-saturated magnetization with a first magnetization intensity to a to-be-inspected pipeline;
applying a magnetization with a second magnetization intensity to a local pipeline-segment of the to-be-inspected pipeline covered by a gradient-augmented magnetization probe;
detecting a magnetic induction intensity on a surface of the local pipeline-segment of the to-be-inspected pipeline after the superimposition of the non-saturated magnetization with the first magnetization intensity and the magnetization with the second magnetization intensity;
judging whether the magnetic induction intensity on the surface of the local pipeline-segment of the to-be-inspected pipeline reaches a preset magnetic induction intensity threshold, and the magnetic induction intensity on the surface of the local pipeline-segment of the to-be-inspected pipeline reaching the preset magnetic induction intensity threshold, indicates saturated magnetization in the local pipeline-segment of the to-be-inspected pipeline; and
collecting magnetic flux leakage information of a leakage magnetic field in space in real time, and outputting a voltage signal corresponding to the magnetic flux leakage information when there is the magnetic flux leakage information in space.

The embodiments of the present disclosure provide a gradient-augmented saturation magnetization internal inspection device for oil and gas pipelines and a method therefor, and a local area of a pipeline covered by a magnetic flux leakage detection probe reaches a saturation magnetization through a gradient-augmented excitation method, and the gradient-augmented saturation magnetization internal inspection device includes a pipeline-segment excitation assembly and a plurality of probe local excitation assemblies. A non-saturated magnetization is applied to a to-be-inspected pipeline by the pipeline-segment excitation assembly, and a saturation magnetization is applied to a local pipeline-segment of the to-be-inspected pipeline by the probe local excitation assemblies. Under the superposition effect of the pipeline-segment excitation assembly and the probe local excitation assemblies, the local area of the pipeline covered by the probe achieves a saturation magnetization, thereby achieving a gradient-augmented saturation magnetization in the local area of the pipeline. When there are defects in the pipeline-segment in the area covered by the probe, some magnetic flux lines leak out from a material surface to form a leakage magnetic field, and the leakage magnetic field is detected by a magnetic sensitive element inside the probe, thereby achieving a lightweight in-pipeline defect magnetic flux leakage detection.

### BRIEF DESCRIPTION OF THE DRAWINGS

In order to more clearly illustrates the technical solutions in the embodiments of the present disclosure or in the prior art, the drawings to be used in the description of the embodiments or the prior art will be briefly introduced as follows. Obviously, the drawings involved in the following description just illustrate some embodiments of the present disclosure, and those of ordinary skill in the art can obtain other drawings from these drawings without paying any inventive effort. In the drawings,

FIG. 1 illustrates a schematic diagram of a gradient-augmented saturation magnetization internal inspection device for oil and gas pipelines according to an embodiment of the present disclosure;

FIG. 2 illustrates a three-dimensional structural diagram of a gradient-augmented saturation magnetization internal inspection device for oil and gas pipelines according to an embodiment of the present disclosure;

FIG. 3 illustrates a side-view three-dimensional structural diagram of a gradient-augmented magnetization probe according to an embodiment of the present disclosure;

FIG. 4 illustrates a top-view three-dimensional structural diagram of a gradient-augmented magnetization probe according to an embodiment of the present disclosure;

FIG. 5 illustrates a three-dimensional structural diagram of a probe local excitation assembly according to an embodiment of the present disclosure;

FIG. 6 illustrates a flowchart of a gradient-augmented saturation magnetization internal inspection method for oil and gas pipelines according to an embodiment of the present disclosure; and

FIG. 7 illustrates a graph of a magnetization intensity variation in a local area of a to-be-inspected pipeline according to an embodiment of the present disclosure.

### DESCRIPTION OF THE EMBODIMENTS

In order that those skilled in the art can better understand the solutions of the present disclosure, the technical solutions in the embodiments of the present disclosure will be clearly and completely described below with reference to the drawings for the embodiments of the present disclosure. Obviously, those described are merely a part, rather than all, of the embodiments of the present disclosure. Based on the embodiments of the present disclosure, any other embodiment obtained by those of ordinary skill in the art without inventive efforts should fall within the protection scope of the present disclosure.

It should be noted that the terms “first”, “second”, etc. in the description and claims of the present disclosure and the above drawings are used to distinguish similar objects, and are not necessarily used to describe a specific sequence or order of precedence. It should be understood that the data thus used can be interchanged under appropriate circumstances to facilitate the description of the embodiments herein. Moreover, the terms “comprise”, “include” and “have”, as well as any variations thereof, are intended to cover non-exclusive inclusions. For example, a process, method, system, product, or device that includes a series of steps or units is not necessarily limited to the steps or units clearly listed, but may include other steps or units not clearly listed or inherent to the process, method, product, or device.

In the present disclosure, the terms such as “upper and on”, “lower”, “left”, “right”, “front”, “rear”, “top”, “bottom”, “inner”, “outer”, “middle”, “vertical”, “horizontal”, “lateral”, and “longitudinal” indicate orientations or positional relationships based on those illustrated in the drawings. These terms are mainly used to better describe the present disclosure and the embodiments thereof, rather than to limit a device, element, or component indicated to have a specific orientation, or to be constructed and operated in a specific orientation.

Moreover, in addition to being used to indicate orientations or positional relationships, some of the above terms may also be used to denote other meanings. For example, the term “upper and on” may also be used to indicate an attachment relationship or a connection relationship in some cases. For those of ordinary skill in the art, the specific meanings of these terms in the present disclosure can be understood according to the specific circumstances.

In addition, the term “mount”, “dispose”, “provided with”, “connect”, “connected to”, or “sleeve” should be broadly construed, e.g., it may be a fixed connection, a detachable connection, an integral configuration, a mechanical connection, an electrical connection, a direct connection, an indirect connection by an intermediate medium, or a communication between the interiors of two devices, elements, or components. For those of ordinary skill in the art, the specific meaning of the above terms in the present disclosure can be understood according to the specific circumstances.

It should be noted that, in the case of no conflict, the embodiments of the present disclosure and the features in the embodiments may be combined with each other. The present disclosure will be described in detail below with reference to the drawings and in conjunction with the embodiments.

In order to carry out a magnetic flux leakage detection on internal and external defects of medium-and-low-pressure oil and gas pipelines, the present disclosure provides a gradient-augmented saturation magnetization internal inspection device for oil and gas pipelines, which applies an external magnetic field to a to-be-inspected pipeline to magnetize the to-be-inspected pipeline to a non-saturated magnetization state, and then applies an external magnetic field to a local pipeline-segment of the to-be-inspected pipeline to magnetize the local pipeline-segment of the to-be-inspected pipeline to a saturation state. When there are internal and external defects in the to-be-inspected pipeline, some magnetic flux lines may leak out from the surface of the pipeline to form a leakage magnetic field, and the presence and the characteristics of the defects can be determined by a magnetic flux leakage signal of the leakage magnetic field detected through a magnetic sensitive element of the gradient-augmented saturation magnetization internal inspection device.

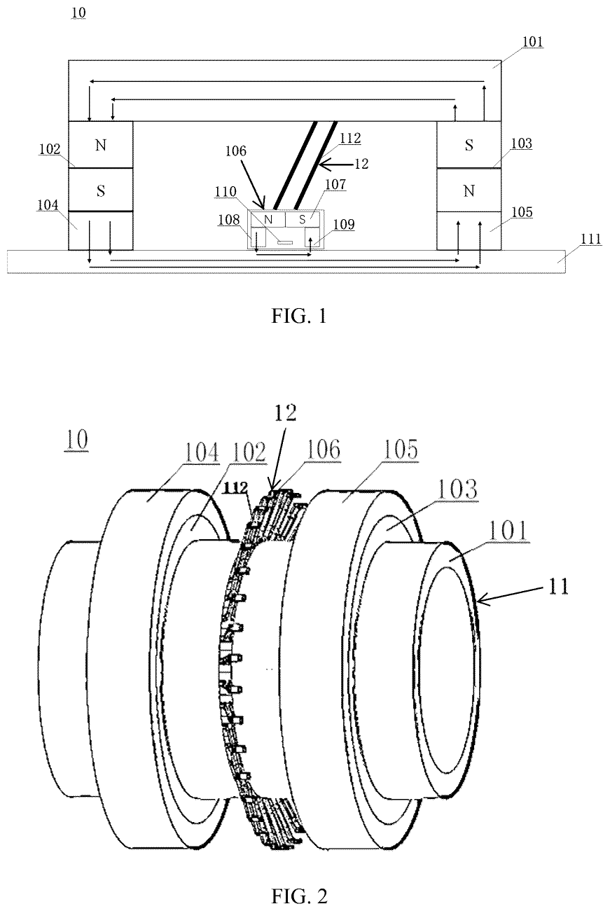

As illustrated in FIGS. 1 and 2, the gradient-augmented saturation magnetization internal inspection device 10 includes a pipeline-segment excitation assembly 11 and a plurality of probe local excitation assemblies 12.

As illustrated in FIG. 2, the pipeline-segment excitation assembly 11 includes an annular rigid framework 101, pipeline-segment magnetization magnets 102 and 103, and pipeline-segment steel brushes 104 and 105, and each of the pipeline-segment magnetization magnets 102 and 103 is composed of a set of annular magnets; and each of the pipeline-segment steel brushes 104 and 105 is composed of a set of annular yokes.

The pipeline-segment magnetization magnets 102 and 103 are respectively sleeved over an outer sidewall of the annular rigid framework 101, and are oppositely polarized. The pipeline-segment steel brush 104 is sleeved over an outer sidewall of the pipeline-segment magnetization magnet 102, and the pipeline-segment steel brush 105 is sleeved over an outer sidewall of the pipeline-segment magnetization magnet 103.

As illustrated in FIGS. 1 and 2, when the gradient-augmented saturation magnetization internal inspection device 10 is disposed in a to-be-inspected pipeline 111, the pipeline-segment steel brushes 104 and 105 are attached to an inner wall of the to-be-inspected pipeline 111, so that the annular rigid framework 101, together with the pipeline-segment magnetization magnets 102 and 103, the pipeline-segment steel brushes 104 and 105, and the to-be-inspected pipeline 111, collectively forms a first magnetic field circuit, so as to apply non-saturated magnetization to the to-be-inspected pipeline 111.

As illustrated in FIGS. 1 and 2, the plurality of probe local excitation assemblies 12 are disposed in a circumferential array on the annular rigid framework 101. As illustrated in FIGS. 1, 3 and 4, the probe local excitation assemblies 12 includes gradient-augmented magnetization probes 106 and probe brackets 112. One end of each probe bracket 112 is fixed on the annular rigid framework 101, and the other end of each probe bracket 112 is connected to the gradient-augmented magnetization probe 106, so that the probe local excitation assemblies 12 are arranged circumferentially on the annular rigid framework 101.

In an embodiment, the annular rigid framework 101 is a carbon steel mechanical framework of the gradient-augmented saturation magnetization internal inspection device 10. The above annular magnet is made of ferrite with a high magnetic permeability, and the above annular yoke is made of neodymium iron boron with a high coercive force.

In an embodiment, the plurality of probe local excitation assemblies 12 are disposed at the middle of the annular rigid framework 101 to perform an array detection of magnetic flux leakage information of the leakage magnetic field of the to-be-inspected pipeline 111.

As illustrated in FIGS. 1 and 2, the gradient-augmented magnetization probe 106 includes: a probe magnetization magnet 107, probe yokes 108 and 109, and a magnetic sensitive element 110.

When the gradient-augmented saturation magnetization internal inspection device 10 is disposed in the to-be-inspected pipeline 111, all the gradient-augmented magnetization probes 106 are attached to an inner wall of the pipeline-segment of the to-be-inspected pipeline 111 along a circumferential direction of the to-be-inspected pipeline 111; and the probe yokes 108 and 109, the probe magnetization magnet 107, and the local pipeline-segment of the to-be-inspected pipeline 111 collectively form a magnetic field circuit, enabling a saturation magnetization in the local pipeline-segment of the to-be-inspected pipeline 111 covered by the gradient-augmented magnetization probe 106.

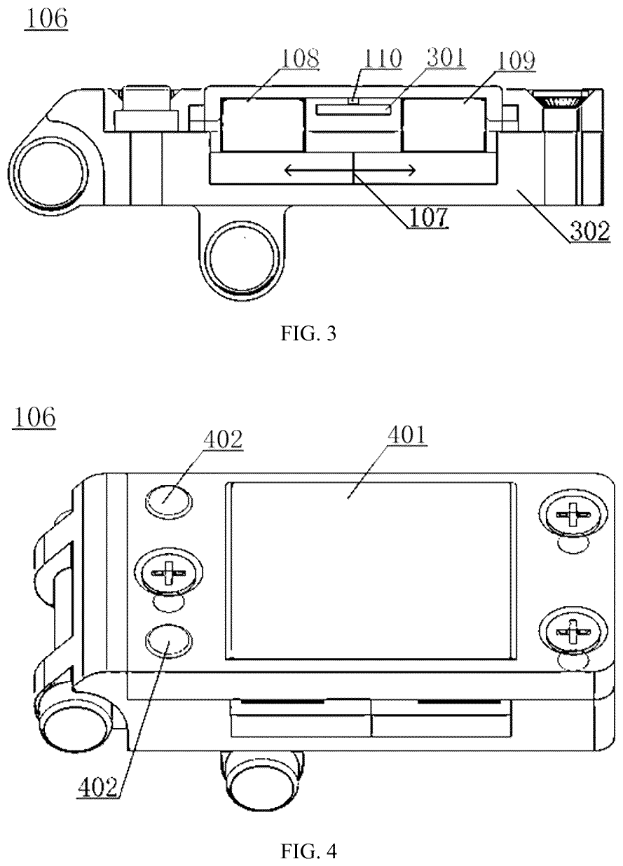

In an embodiment, a longitudinal direction of the probe magnetization magnet 107 is aligned with an axial direction of the to-be-inspected pipeline 111. As illustrated in FIG. 3, an arrow direction is parallel to the axial direction of the to-be-inspected pipeline 111. A direction of the magnetic field circuit formed by the pipeline-segment excitation assembly 11 and the to-be-inspected pipeline 111 is consistent with a direction of the magnetic field circuit formed by the gradient-augmented magnetization probe 106 and the local pipeline-segment of the to-be-inspected pipeline 111.

In an embodiment, the probe yokes 108 and 109 are made of neodymium iron boron with a high coercive force. The probe magnetization magnet 107 is made of ferrite with a high magnetic permeability. The magnetic sensitive element 110 may be a Hall element, a Tunnel magnetoresistance element (TMR) element, an Anisotropic magnetoresistance element (AMR) element, or the like, and is configured to collect magnetic flux leakage information of the leakage magnetic field in space.

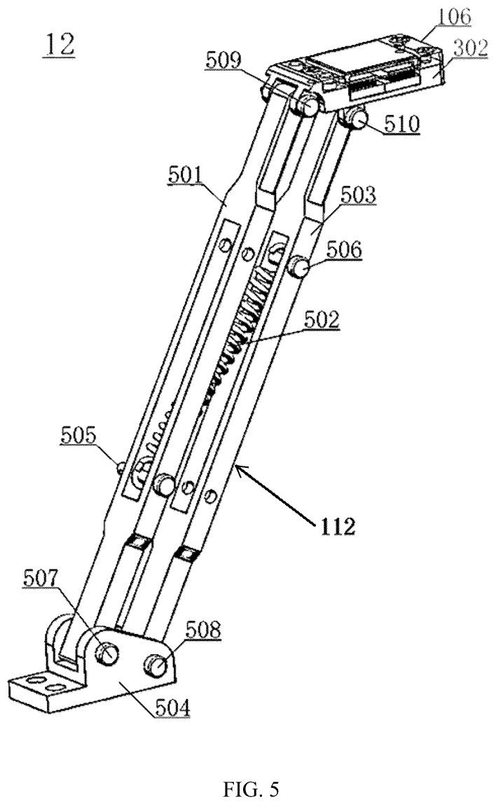

As illustrated in FIGS. 3 and 4, the gradient-augmented magnetization probe 106 further includes a printed circuit board (PCB) 301, a probe framework 302, a wear-resistant plate 401, and a plurality of wear-resistant pins 402.

Specifically, the printed circuit board 301 is disposed between the probe yoke 108 and the probe yoke 109, the magnetic sensitive element 110 is disposed on the PCB 301, and the probe yokes 108 and 109 are disposed on the probe magnetization magnet 107.

As illustrated in FIGS. 3 and 4, the probe yokes 108 and 109, the magnetic sensitive element 110, the printed circuit board 301, and the probe magnetization magnet 107 are encapsulated within the probe framework 302 through the wear-resistant plate 401 and two wear-resistant pins 402. The wear-resistant plate 401 covers the probe yokes 108 and 109, and the magnetic sensitive element 110.

In an embodiment, the wear-resistant plate 401 is made of ceramic and configured to protect the core components of the gradient-augmented magnetization probe 106. The probe framework 302 is configured to support the probe magnetization magnet 107, the probe yokes 108 and 109, and the magnetic sensitive element 110.

As illustrated in FIG. 5, the probe bracket 112 includes: probe support arms 501 and 503, a tension spring 502, a probe base 504, screws 505 and 506, and bolts 507, 508, 509, and 510.

In an embodiment, the upper ends of the probe support arms 501 and 503 are rotatably connected to the probe framework 302. The probe support arms 501 and 503 are rotatably connected to the annular rigid framework 101. One end of the tension spring 502 is fixed on an upper region of the probe support arm 503, and the other end thereof is fixed on a lower region of the probe support arm 501, to achieve a stable connection.

During implementation, the upper region and the lower region of each of the probe support arms 501 and 503 are provided with two through holes, respectively. The lower ends of the probe support arms 501 and 503 are rotatably connected to the probe base 504 through bolts 507 and 508, respectively. The upper ends of the probe support arms 501 and 503 are rotatably connected to the probe framework 302 through bolts 509 and 510, respectively.

In an embodiment, the middle section of each of the probe support arms 501 and 503 is provided with an elongated through-slot, an upper region and a lower region of which are provided with two through holes, respectively. The screw 505 is disposed in the two through holes at the lower region of the probe support arm 501, and the screw 506 is disposed in the two through holes at the upper region of the probe support arm 503. Two ends of the tension spring 502 are provided with hooks, respectively. The hook at one end of the tension spring 502 is hooked on the screw 505, and the hook at the other end of the tension spring 502 is hooked on the screw 506, so that the tension spring 502 is disposed between the probe support arms 501 and 503.

In an embodiment, the probe bracket 112 is a parallelogram bracket configured to support the gradient-augmented magnetization probe 106. The parallelogram bracket keeps a detection plane of the gradient-augmented magnetization probe 106 parallel to the inner wall of the to-be-inspected pipeline, so as to ensure that the magnetic sensitive element 110 can collect axial, radial and circumferential leakage magnetic field information of the to-be-inspected pipeline in real time. The tension spring 502 provides a tensile force to the probe bracket 112, so that the gradient-augmented magnetization probe 106 remains in close contact with the inner wall of the to-be-inspected pipeline.

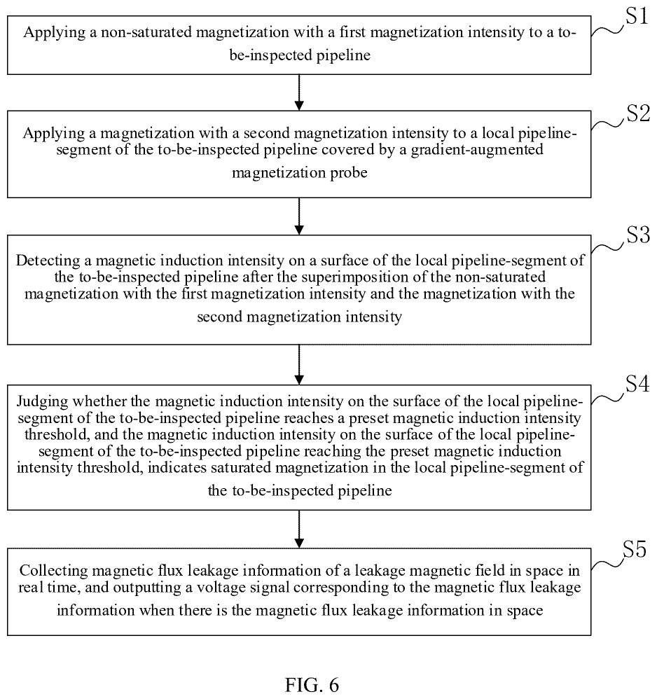

As illustrated in FIG. 6, the present disclosure further provides a gradient-augmented saturation magnetization internal inspection method for oil and gas pipelines. Before a to-be-inspected pipeline 111 is inspected, a gradient-augmented saturation magnetization internal inspection device 10 is put into the to-be-inspected pipeline 111. The gradient-augmented saturation magnetization internal inspection method for oil and gas pipelines includes Step 1 to Step 5.
Step 1: applying a non-saturated magnetization with a first magnetization intensity to a to-be-inspected pipeline.
Step 2: applying a magnetization with a second magnetization intensity to a local pipeline-segment of the to-be-inspected pipeline covered by a gradient-augmented magnetization probe.
Step 3: detecting a magnetic induction intensity on a surface of the local pipeline-segment of the to-be-inspected pipeline after the superimposition of the non-saturated magnetization with the first magnetization intensity and the magnetization with the second magnetization intensity.
Step 4: judging whether the magnetic induction intensity on the surface of the local pipeline-segment of the to-be-inspected pipeline reaches a preset magnetic induction intensity threshold, and the magnetic induction intensity on the surface of the local pipeline-segment of the to-be-inspected pipeline reaching the preset magnetic induction intensity threshold, indicates saturated magnetization in the local pipeline-segment of the to-be-inspected pipeline.
Step 5: collecting magnetic flux leakage information of a leakage magnetic field in space in real time, and outputting a voltage signal corresponding to the magnetic flux leakage information when there is the magnetic flux leakage information in space.

As can be seen from the flow illustrated in FIG. 6, in the embodiments of the present disclosure, the non-saturated magnetization with the first magnetization intensity is applied to the to-be-inspected pipeline, and then the local pipeline-segment of the to-be-inspected pipeline is magnetized to a second magnetization level. Under the superposition effect of the pipeline-segment excitation assembly and the probe local excitation assemblies, the local pipeline-segment of the to-be-inspected pipeline covered by the probe achieves a saturation magnetization, thereby achieving a gradient-augmented saturation magnetization in a local area of the pipeline. When there are defects in the pipeline-segment in the area covered by the probe, some magnetic flux lines may leak into the space and be captured by the magnetic sensitive element, thereby achieving a lightweight magnetic flux leakage internal inspection of the defects of the pipeline.

Each step is explained in detail below.

Step 1: applying a non-saturated magnetization with a first magnetization intensity to a to-be-inspected pipeline 111.

In this embodiment, the first magnetization intensity is a non-saturated magnetization intensity M₁.

Specifically, a magnetic field circuit is formed by an annular rigid framework 101, pipeline-segment magnetization magnets 102 and 103, pipeline-segment steel brushes 104 and 105 and the to-be-inspected pipeline 111, with a magnetic field direction as illustrated in FIG. 1. The non-saturated magnetization with the non-saturated magnetization intensity of M₁ is applied to the to-be-inspected pipeline 111 by a pipeline-segment excitation assembly 11. At this time, the magnetic field intensity inside the to-be-inspected pipeline 111 is H₁, which is far less than a preset magnetic field intensity threshold Hₘₐₓ, that is, Hₘₐₓ is a saturation magnetic field intensity.

In an embodiment, the magnetic field intensity inside the to-be-inspected pipeline 111 is determined by a magnetic susceptibility formula.

$$X = \frac{M}{H} \qquad ( 1 )$$

where X denotes the magnetic susceptibility, with a unit of H/m; M denotes the magnetization, with a unit of A/m; and H denotes the magnetic field intensity, with a unit of A/m.

Step 2: applying a magnetization with a second magnetization intensity to a local pipeline-segment of the to-be-inspected pipeline 111 covered by a gradient-augmented magnetization probe 106, and the second magnetization intensity is a magnetization intensity M₂.

Specifically, the gradient-augmented magnetization probe 106 is in contact with the inner wall of the to-be-inspected pipeline 111 under the action of the probe bracket 112 and the magnetic attraction inside the probe. A magnetic field circuit is formed by the probe yoke 108, the probe yoke 109 and the probe magnetization magnet 107 all of which are inside the gradient-augmented magnetization probe 106 and the local pipeline-segment of the to-be-inspected pipeline 111, with a magnetic field direction as illustrated in FIG. 1. Magnetization with the magnetization intensity M₂ is applied to the local pipeline-segment of the to-be-inspected pipeline 111 by the gradient-augmented magnetization probe 106, and the magnetic field intensity H₂ at the magnetization intensity M₂ is calculated by formula (1).

Step 3: detecting a magnetic induction intensity Bₛ on a surface of the local pipeline-segment of the to-be-inspected pipeline 111 after the superimposition of the non-saturated magnetization with the first magnetization intensity and the magnetization with the second magnetization intensity.

Specifically, under the superposition effect of the pipeline-segment excitation assembly 11 and the probe local excitation assemblies 12, the internal magnetic field intensity of the local pipeline-segment of the to-be-inspected pipeline 111 covered by the gradient-augmented magnetization probe 106 is Hₛ, that is, Hₛ=H₁+H₂. The magnetic induction intensity Bₛ on the outer surface of the to-be-inspected pipeline 111 covered by the gradient-augmented magnetization probe 106 is measured by a Gauss meter.

Step 4: judging whether the magnetic induction intensity Bₛ on the surface of the local pipeline-segment of the to-be-inspected pipeline 111 reaches a preset magnetic induction intensity threshold Bₘₐₓ, and the magnetic induction intensity Bₛ on the surface of the local pipeline-segment of the to-be-inspected pipeline 111 reaching the preset magnetic induction intensity threshold Bₘₐₓ, indicates saturated magnetization in the local pipeline-segment of the to-be-inspected pipeline 111.

Step 5: collecting magnetic flux leakage information of a leakage magnetic field in space in real time, and outputting a voltage signal corresponding to the magnetic flux leakage information when there is the magnetic flux leakage information in space.

Specifically, after the local pipeline-segment of the to-be-inspected pipeline 111 covered by the gradient-augmented magnetization probe 106 reaches saturation magnetization, the magnetic field information of the leakage magnetic field in space is detected by the magnetic sensitive element 110 inside the gradient-augmented magnetization probe 106. When there are internal and external defects in the to-be-inspected pipeline 111 under local saturation magnetization, some magnetic flux lines may leak into the space and be captured by the magnetic sensitive element 110 inside the gradient-augmented magnetization probe 106, and the gradient-augmented magnetization probe 106 outputs a voltage signal corresponding to the magnetic flux leakage information, thereby achieving the magnetic flux leakage detection of the local pipeline-segment of the to-be-inspected pipeline 111.

In an embodiment, the voltage signal output by the gradient-augmented magnetization probe 106 is stored.

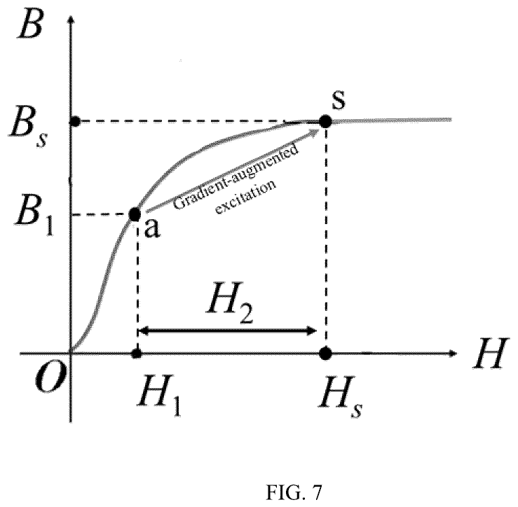

As illustrated in FIG. 7, when the non-saturated magnetization with the magnetization intensity M₁ is applied to the to-be-inspected pipeline 111, the magnetic field intensity inside the to-be-inspected pipeline is H₁. At this time, the to-be-inspected pipeline is magnetized to point a, the magnetic induction intensity of the wall of the to-be-inspected pipeline corresponding to magnetic field intensity H₁ is B₁, and the to-be-inspected pipeline 111 is in a non-saturated magnetization state.

Specifically, the magnetic field intensity H₁ is calculated by formula (1), that is, H₁=M₁/X. The magnetic induction intensity B₁ corresponding to the magnetic field intensity H₁ is calculated by formula (2):

$$B = μ ( H + M ) \qquad ( 2 )$$

where B denotes the magnetic induction intensity, μ denotes the magnetic permeability in vacuum, H denotes the magnetic field intensity and M denotes the magnetization intensity.

That is, B₁=μ(H₁+M₁).

When the magnetization with the magnetization intensity M₂ is applied to the local pipeline-segment of the to-be-inspected pipeline 111 covered by the gradient-augmented magnetization probe 106, the local pipeline-segment of the to-be-inspected pipeline is further magnetized from point a to point s, the magnetic induction intensity of the wall of the local pipeline-segment of the to-be-inspected pipeline corresponding to the magnetic field intensity Hₛ is Bₛ, and the local pipeline-segment of the to-be-inspected pipeline 111 is in a saturation magnetization state.

Specifically, the magnetic field intensity H₂ is calculated by formula (1), that is, H₂=M₂/X. The magnetic induction intensity B₂ corresponding to the magnetic field intensity H₂ is calculated by formula (2), that is, B₂=μ(H₂+M₁). Thus, the magnetic induction intensity Bₛ=B₁+B₂, and the magnetic field intensity Hₛ=H₁+H₂.

The specific embodiments described above make further detailed explanations to the objectives, technical solutions and advantageous effects of the present disclosure. It should be understood that those described above are only specific embodiments of the present disclosure and are not intended to limit the protection scope of the present disclosure. Any modification, equivalent substitution, improvement, etc. made within the spirit and principle of the present disclosure should fall within the protection scope of the present disclosure.

What is claimed is:

1. A gradient-augmented saturation magnetization internal inspection device for oil and gas pipelines, comprising a pipeline-segment excitation assembly and a plurality of probe local excitation assemblies, wherein:
the pipeline-segment excitation assembly comprises an annular rigid framework, a first pipeline-segment magnetization magnet, a second pipeline-segment magnetization magnet, a first pipeline-segment steel brush and a second pipeline-segment steel brush, wherein:
the first pipeline-segment magnetization magnet, the second pipeline-segment magnetization magnet, the first pipeline-segment steel brush and the second pipeline-segment steel brush are all annular structures;
the first pipeline-segment magnetization magnet and the second pipeline-segment magnetization magnet are respectively sleeved over an outer sidewall of the annular rigid framework, and are oppositely polarized; and the first pipeline-segment steel brush is sleeved over an outer sidewall of the first pipeline-segment magnetization magnet; and
the second pipeline-segment steel brush is sleeved over an outer sidewall of the second pipeline-segment magnetization magnet; and
the plurality of probe local excitation assemblies comprise gradient-augmented magnetization probes and probe brackets, and the gradient-augmented magnetization probes are disposed in a circumferential array on the annular rigid framework through the probe brackets.

2. The device according to claim 1, wherein when the gradient-augmented saturation magnetization internal inspection device is disposed in a to-be-inspected pipeline, the first pipeline-segment steel brush and the second pipeline-segment steel brush are attached to an inner wall of the to-be-inspected pipeline, so that the annular rigid framework, together with the first pipeline-segment magnetization magnet, the second pipeline-segment magnetization magnet, the first pipeline-segment steel brush, the second pipeline-segment steel brush and the to-be-inspected pipeline collectively forms a first magnetic field circuit.

3. The device according to claim 2, wherein the gradient-augmented magnetization probe comprises a first probe yoke, a second probe yoke, a probe magnetization magnet and a magnetic sensitive element; wherein the first probe yoke, the probe magnetization magnet, the second probe yoke and the to-be-inspected pipeline form a second magnetic field circuit; and wherein the first magnetic field circuit and the second magnetic field circuit are in a same direction.

4. The device according to claim 3, wherein the gradient-augmented magnetization probe further comprises a printed circuit board on which the magnetic sensitive element is disposed, the magnetic sensitive element and the printed circuit board are disposed between the first probe yoke and the second probe yoke, and the first probe yoke and the second probe yoke are disposed on the probe magnetization magnet.

5. The device according to claim 4, wherein:
the gradient-augmented magnetization probe further comprises a wear-resistant plate, a plurality of wear-resistant pins and a probe framework;
the magnetic sensitive element, the printed circuit board, the first probe yoke, the second probe yoke and the probe magnetization magnet are encapsulated within the probe framework; and
the wear-resistant plate covers the magnetic sensitive element, the first probe yoke and the second probe yoke and is fixed by the wear-resistant pins.

6. The device according to claim 5, wherein:
the probe bracket comprises two probe support arms and a tension spring;
one end of either of the probe support arms is rotatably connected to the probe framework, and the other end of either of the probe support arms is rotatably connected to the annular rigid framework; and
one end of the tension spring is fixed on an upper region of one of the probe support arms, and the other end of the tension spring is fixed on a lower region of the other of the probe support arms.

7. The device according to claim 6, wherein the probe bracket further comprises a plurality of screws, either of the probe support arms is provided with an elongated through-slot, one end of the tension spring is fixed on an upper region of the elongated through-slot of one of the probe support arms through the screws, and the other end of the tension spring is fixed on a lower region of the elongated through-slot of the other of the probe support arms.

8. The device according to claim 7, wherein the probe bracket further comprises a plurality of bolts and a probe base, wherein the probe base is fixed on the annular rigid framework, and the probe support arms are rotatably connected to the probe base through the bolts.

9. The device according to claim 3, wherein a longitudinal direction of the probe magnetization magnet is aligned with an axial direction of the to-be-inspected pipeline.

10. A gradient-augmented saturation magnetization internal inspection method for oil and gas pipelines, comprising:
applying a non-saturated magnetization with a first magnetization intensity to a to-be-inspected pipeline;
applying a magnetization with a second magnetization intensity to a local pipeline-segment of the to-be-inspected pipeline covered by a gradient-augmented magnetization probe;
detecting a magnetic induction intensity on a surface of the local pipeline-segment of the to-be-inspected pipeline after the superimposition of the non-saturated magnetization with the first magnetization intensity and the magnetization with the second magnetization intensity;
judging whether the magnetic induction intensity on the surface of the local pipeline-segment of the to-be-inspected pipeline reaches a preset magnetic induction intensity threshold, and the magnetic induction intensity on the surface of the local pipeline-segment of the to-be-inspected pipeline reaching the preset magnetic induction intensity threshold, indicates saturated magnetization in the local pipeline-segment of the to-be-inspected pipeline; and
collecting magnetic flux leakage information of a leakage magnetic field in space in real time, and outputting a voltage signal corresponding to the magnetic flux leakage information when there is the magnetic flux leakage information in space.
